(19) United States
(12) Patent Application Publication
(10) Pub. No.: US 2008/0012719 A1
(43) Pub. Date: Jan. 17, 2008

(54) Adjustable light barrier member

(76) Inventor: Michael Hoermann, Halle/Westfalen (DE)

Correspondence Address: DILWORTH & BARRESE, LLP, 333 EARLE OVINGTON BLVD., SUITE 702, UNIONDALE, NY, 11553, US

(21) Appl. No.: 11/824,989

(22) Filed: Jul. 3, 2007

(30) Foreign Application Priority Data
Jul. 4, 2006 (DE) UM202006010344.9
Jul. 20, 2006 (DE) UM202006011219.7

(51) Int. Cl. G08B 21/00

(52) U.S. Cl. 340/657

(57) ABSTRACT

The present invention relates to an adjustable light barrier member comprising at least one control display, a fastening housing and a transmitter or receiver member rotatable in the fastening housing, with the control display being arranged at the pivot axle of the transmitter or receiver member.

The present invention relates to an adjustable light barrier member comprising at least one control display, a fastening housing and a transmitter or receiver member rotatable in the fastening housing.

Light barriers comprising such light barrier members are in particular used with garage door controls to permit an automatic control of the garage door drive or to satisfy safety functions.

In this connection, a light barrier usually includes two light barrier members: a light barrier transmitter which transmits the light beam of the light barrier and a light barrier receiver which receives the light beam radiated from the light barrier transmitter. In this connection, the light barrier members have to be aligned to one another to ensure a problem-free function of the light barrier. For this purpose, the transmitter or receiver member of the respective light barrier member is rotatable in the fastening housing. On this adjustment of the light barrier members, problems frequently occur in practice since the light barrier transmitter has to be aligned very accurately on the light barrier receiver or the latter very accurately on the light barrier transmitter due to the small optical opening angles of the light beam of less than +/−5°. These small opening angles are, however, advantageous since unwanted reflections, e.g. at the door or at the floor covering, can thus be prevented. The opening angles of the light barriers therefore tend to be chosen to be even lower than the aforesaid +/−5°. Problems moreover additionally arise in the adjustment of the light barrier members because the used infrared light of the light barrier is not visible and the optical axes are also usually not recognizable due to the housing shape.

A control display is therefore provided for the facilitation of the adjustment of a light barrier member and the alignment associated therewith of the transmitter or receiver member rotatable in a fastening housing, said control display signaling the functioning of the light barrier and with the correct adjustment of the light barrier member being able to be displayed by it.

However, the problem arises in this connection that a control display attached to the transmitter or receiver member can only be recognized with difficulty due to the fastening housing surrounding the rotatable transmitter or receiver member. Other arrangements of the control display can, however, be very expensive and/or complex.

It is therefore the object of the present invention to provide an adjustable light barrier member in which the control display is easily visible and which has a simple structure.

This object is solved in accordance with the invention by an adjustable light barrier member in accordance with claim 1. In such an adjustable light barrier member having at least one control display, a fastening housing and a transmitter or receiver member rotatable in the fastening housing, the control display is arranged in accordance with the invention at the pivot axle of the transmitter or receiver member. The control display is hereby visible very easily from the outside and can nevertheless be connected in a simple manner to the electronics arranged in the transmitter or receiver member.

In a further advantageous manner, the control display is arranged at an end of the pivot axle which passes through an opening in the fastening housing. The opening in the fastening housing is anyway present to receive the pivot axle of the transmitter or receiver member so that the control display arranged at the end of the pivot axle passing through this opening is located at the outer side of the fastening housing and is thus arranged in an easily visible manner.

Control displays are advantageously arranged at both ends of the pivot axle in this connection. The function of the light barrier can thus be checked easily from both sides of the fastening housing.

The pivot axle of the transmitter or receiver member is advantageously fixedly connected to the transmitter or receiver member. The control display arranged at the pivot axle can thus also be connected to the electronics located in the transmitter or receiver member without this connection being exposed to mechanical strains by a rotation or movement of the transmitter or receiver member. The wear is thus also reduced and an expensive and/or complex flexible connection between the transmitter or receiver member and the control display can be dispensed with.

The pivot axle of the transmitter or receiver member is advantageously rotatably journaled in the fastening housing. This is effected in a particularly advantageous manner in that the ends of the pivot axle pass through two openings arranged in oppositely disposed side walls of the fastening housing. The pivot axle can thus be rotated together with the transmitter or receiver member in the fastening housing and thus permits a simple adjustment of the light barrier.

The pivot axle advantageously has an axial opening at least one end in which the control display is arranged. The control display thus only projects a little out of the fastening housing and can nevertheless be easily recognized.

In a further advantageous manner, the pivot axle includes a hollow cylinder. Both the control display and the electrical connections between the control display and the electronics located in the transmitter or receiver member can then be arranged in the interior of this hollow cylinder. This permits a particularly simple and wear-free arrangement of the control display.

In a further advantageous manner, the control display includes a control lamp or an LED. It can be displayed by the lighting up of the control lamp or of the LED whether the light barrier is working so that the correct adjustment of the transmitter or receiver member can be evaluated in a simple manner.

The present invention will now be described in more detail with reference to an embodiment.

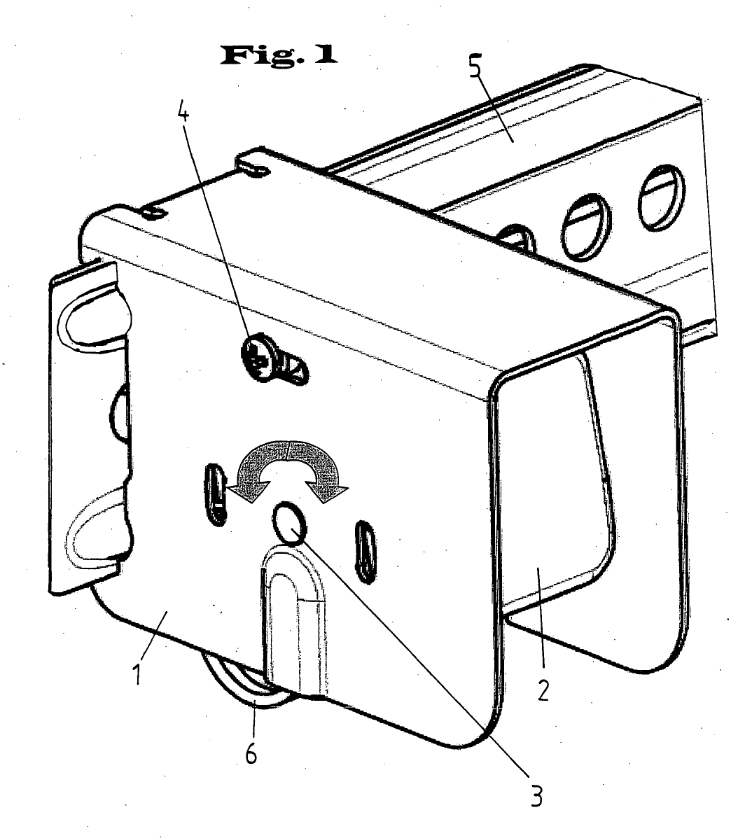

In this connection, FIG. 1 shows a perspective view of an embodiment of the present invention.

As can be seen in FIG. 1, the adjustable light barrier member in accordance with the invention comprises a transmitter or receiver member 2 which is rotatably installed in the fastening housing 1. A control display is arranged at both ends on the pivot axle 3 which passes through two openings on oppositely disposed sides of the fastening housing 1 and is fixedly connected to the transmitter or receiver member 2. It is displayed by this control display whether the light barrier is working properly. To now align the light barrier transmitter to the light barrier receiver of the light barrier, or vice versa, and thus to adjust the light barrier, the transmitter or receiver member 2 can be rotated in the fastening housing until the control display displays a proper working of the light barrier and the light barrier member is correctly adjusted. The transmitter or receiver member can then be fixed in the correct position by a fixing member 4. The fixing member 4 in this connection comprises a screw which runs in a groove in the fastening housing and can be screwed into the transmitter or receiver member so that the transmitter or receiver member can be fixed in the correct adjustment position by tightening the screw 4.

Since the control display, which can comprise e.g. a control lamp or an LED, is arranged in the end region of the pivot axle 3, the control display can be viewed very easily. In order to further improve the visibility and to permit a control display on both sides of the fastening housing, a control display is also arranged in the end region of the pivot axle on the other side of the housing not shown here. In this connection, the control display projects slightly out of the fastening housing so that every single control display can be seen from an angular range of 180°. The control display is fixedly connected to the transmitter or receiver member 2 so that it is not mechanically stressed by the rotation of the transmitter or receiver member 2.

The fastening housing 1 is in turn fastenable to an installation rail 5 and can be displaced along this installation rail 5 so that the position of the light barrier member along the installation rail 5 can be varied. The installation rail 5 likewise serves the guidance of the cable 6 which leads to the transmitter or receiver member 2. The fastening housing 1 comprises a metal sheet which has been bent into a U shape and in whose oppositely disposed sides cut-outs are provided for the reception of the pivot axle of the transmitter or receiver member. The fastening member can be pushed onto the installation rail 5 at the open rear side through projecting members, whereas the light beam radiated from the transmitter member or received by the receiver member can pass through the open front side of the fastening housing without hindrance.

1. An adjustable light barrier member comprising at least one control display, a fastening housing and a transmitter or receiver member rotatable in the fastening housing,
characterized in that
the control display is arranged at the pivot axle of the transmitter or receiver member.

2. An adjustable light barrier member in accordance with claim 1, wherein the control display is arranged at an end of the pivot axle which passes through an opening in the fastening housing.

3. An adjustable light barrier member in accordance with claim 1, wherein control displays are arranged at both ends of the pivot axle.

4. An adjustable light barrier member in accordance with claim 1, wherein the pivot axle of the transmitter or receiver member is fixedly connected to the transmitter or receiver member.

5. An adjustable light barrier member in accordance with claim 1, wherein the pivot axle of the transmitter or receiver member is rotatably journaled in the fastening housing.

6. An adjustable light barrier member in accordance with claim 1, wherein the pivot axle has an axial opening at least one end in which the control display is arranged.

7. An adjustable light barrier member in accordance with claim 1, wherein the pivot axle includes a hollow cylinder.

8. An adjustable light barrier member in accordance with claim 1, wherein the control display includes a control lamp or an LED.
